(19) United States
(12) Patent Application Publication
(10) Pub. No.: US 2011/0160101 A1
(43) Pub. Date: Jun. 30, 2011

(54) RESIN COATED PARTICULATES

(76) Inventors: Bryan Naderhoff, Durham, NC (US); Alan Toman, Apex, NC (US)

(21) Appl. No.: 12/971,066

(22) Filed: Dec. 17, 2010

Related U.S. Application Data
(60) Provisional application No. 61/290,307, filed on Dec. 28, 2009.

(51) Int. Cl. C09K 8/62

(52) U.S. Cl. 507/220; 507/219

(57) ABSTRACT

Provided according to embodiments of the invention are resin coated particulates for use in oil and gas subterranean extractions. The resin coated particulates comprise a particulate substrate and a resin coating. The resin coating comprises a particulate substrate and a resin coating including epoxy-functional compounds and an aqueous dispersion of an amine functional microgel wherein the amine functional microgel is formed by reacting a chemical excess of a polyfunctional epoxide compound with an amine salt to form a polyfunctional epoxide amine salt reaction intermediate product, and condensing at least some of the unreacted epoxide groups of the polyfunctional epoxide amine salt reaction intermediate product with a polyamine. Methods of treating a subterranean fracture are also provided.

### CROSS-REFERENCE TO RELATED APPLICATIONS

This application claims priority from U.S. Provisional Application Ser. No. 61/290,307, filed Dec. 28, 2009, the disclosure of which is hereby incorporated by reference herein in its entirety.

### FIELD OF THE INVENTION

The present invention relates to a resin coated particulates for use during oil and gas extraction.

### BACKGROUND OF THE INVENTION

During oil and gas extraction, particulates are added to keep open the subterranean fractures that are formed to access the oil or gas bearing strata. Such fractures are often formed by injecting a viscous fracturing fluid or foam at high pressure into the well to form fractures. As the fracture is formed or shortly after, particulate material is often injected into the well as a suspension to maintain the fracture open, i.e., in a “propped” condition. Thus these particulates are often referred to as “proppants.” When the pressure used to form the fracture is reduced then the particulates or proppants form a pack to maintain the fracture open.

Typically, uncoated particulates such as sand have been used because of their low cost and availability. As drilling depths and well pressures have increased, the uncoated particulates; however, are subjected to high stresses and the particulates may be crushed and fines formed. Such fines may reduce the flow rates or conductivity of hydrocarbons through the particulate by closing the pore spaces of the particulate matrix. This can also be detrimental to piping and valves because of the corrosive nature of the sand in fine form.

It is known to avoid such fines by coating the particulates with a resin. Typical resins are epoxies, furons, phenolics, and mixtures thereof. Exemplary coated particulates or proppants are described in U.S. Pat. Nos. 7,541,318, 7,407,010, 7,270,879, 6,729,404, 6,632,527, 5,916,933, and 5,218,038, the disclosures of which are incorporated herein by reference in their entireties. Phenolics tend to be the most common. Phenol resins; however, have significant disadvantages, particularly in that their by-products of processing include formaldehyde, phenol, and ammonia, may be toxic. These by-products can be of concern for the safety of workers who manufacture the coated proppants and the workers that handle the proppants in the field. In addition, the long term environmental impact of phenolic coated proppants and other oil field chemicals when applied in subterranean zones is a recent public concern. Phenolics also require high temperature melt processing during the coating step which requires a high energy input.

Thus, there is a need for a resin coated particulate or proppant that has reduced toxic by-products and is easy to form.

### SUMMARY OF THE INVENTION

Provided according to embodiments of the invention are resin coated particulates for use in oil and gas subterranean extractions. The resin coated particulates comprise a particulate substrate and a resin coating. The resin coating comprises epoxy-functional compounds and an aqueous dispersion of an amine functional microgel. The amine functional microgel may be formed by reacting a chemical excess of a polyfunctional epoxide compound with an amine salt to form a polyfunctional epoxide amine salt reaction intermediate product, and condensing at least some of the unreacted epoxide groups of the polyfunctional epoxide amine salt reaction intermediate product with a polyamine. Methods of treating a subterranean fracture are also provided.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

All patents, patent applications and publications referred to herein are incorporated by reference in their entirety. In the event of conflicting terminology, the present specification is controlling.

The embodiments described in one aspect of the present invention are not limited to the aspect described. The embodiments may also be applied to a different aspect of the invention as long as the embodiments do not prevent these aspects of the invention from operating for its intended purpose.

The present invention provides a particulate that may have improved crush resistance while not requiring a resin coating that has undesirable properties. The particulate comprises a particulate substrate and a resin coating comprising an epoxy-functional compound and an aqueous dispersion of an amine functional microgel. The amine functional microgel is formed by reacting a chemical excess of a polyfunctional epoxide compound with an amine salt to form a polyfunctional epoxide amine salt reaction intermediate product, and condensing at least some of the unreacted epoxide groups of the polyfunctional epoxide amine salt reaction intermediate product with a polyamine.

Any suitable particulate substrate may be used. Suitable particulate substrates include, but are not limited to, bauxite, ceramic materials, glass materials, nut shells, ground or crushed nut shells, seed shells, ground or crushed seed shells, fruit pit pieces, ground or crushed fruit pits, processed wood, composite particulates prepared from a binder with filler particulate including silica, fumed silica, alumina, fumed carbon, carbon black, graphite, mica, titanium dioxide, meta-silicate, calcium silicate, kaolin, talc, zirconia, boron, fly ash, hollow glass microspheres, and solid glass; or mixtures thereof. The particulate may also be pre-coated with a first coating e.g., nylon, polyurethane or polycarbonate and then coated with epoxy-functional compound and amine microgel.

The particulate substrate may have any suitable particle size. However, in some embodiments, the particulate substrate used may have a particle size in the range of from about 2 to about 400 mesh, U.S. Sieve Series. In particular embodiments, the particulate substrate may include graded sand having a particle size in the range of from about 10 to about 70 mesh, U.S. Sieve Series. Particular sand particle size distribution ranges include one or more of 10-20 mesh, 20-40 mesh, 40-60 mesh or 50-70 mesh. Additionally mixtures of particulates may be utilized.

Suitable epoxy functional compounds include epoxy functional silanes and glycidyl ethers of a polyhydric phenol and / or (poly)hydric alcohols. Suitable functionalized silanes include silanes having one or more functional groups that bind to the particulate substrate and one or more functional groups that bind to the epoxy. In some embodiments, the epoxy functional silane may have the general formula RₙSiX₄₋ₙ wherein R is glycidoxy and 3,4-epoxycyclohexyl, X is methoxy, ethoxy, methyl, and n is 1 to 2. Exemplary epoxy functional silanes include glycidoxy propyl trimethoxy silane, glycidoxy propyl triethoxy silane, glycidoxy propyl methyl diethoxy silane, 3,4-epoxycyclohexyl ethyl trimethoxy silane, and 3,4-epoxycyclohexyl ethyl triethoxy silane.

The glycidyl ethers of a polyhydric phenol and/or a (poly)hydric alcohols have an epoxide equivalent weight of from about 120 to about 700. Exemplary epoxies are the ones based on bisphenol-A and bisphenol-F, such as, but not limited to, the diglycidyl ether of bisphenol-A and the diglycidyl ether of bisphenol-F. Other epoxy resins include, but are not limited to, the diglycidyl ether of tetrabromobisphenol A, epoxy novolacs based on phenol-formaldehyde condensates, epoxy novolacs based on phenol-cresol condensates, epoxy novolacs based on phenol-dicyclopentadiene condensates, diglycidyl ether of hydrogenated bisphenol A, diglycidyl ether of resorcinol, tetraglycidyl ether of sorbitol, and tetra glycidyl ether of methylene dianiline. In addition, epoxy diluents such as glycidyl ethers based on neopentyl glycol, C12-14 alcohol, n-butanol, t-butyl phenol, cresyl glycidyl ether, and polypropylene glycols may be used. Mixtures of any of the above may be employed.

The aqueous dispersions of an amine functional microgel may be prepared by (a) first reacting a chemical excess of a polyfunctional epoxide compound with an amine salt and then (b) condensing the unreacted epoxide groups of the reaction product of (a) with a polyamine such as described in U.S. Pat. Nos. 5,204,385 and 5,369,152, The microgel is a dispersion of polymers in a continuous phase which contains intra-particle bonding or crosslinking within the particles given the dispersed particles gel characteristics. Suitable amine functional microgels are commercially available from Reichhold Inc. as EPOTUF® 37-680 and 37-681. These microgels are aqueous dispersions of amine functional resins supplied at 42% solids in water and ethylene glycol monopropyl ether. The amine hydrogen equivalent weight is about 1350 on a solution basis.

The amine functional microgels of the present invention may result in waterborne coating systems that exhibit excellent wetting and bonding with the sand particles, fast drying times which allow easy processing, and significant improvements in compressive strength or crush resistance compared to uncoated sand. In addition, the coated particulate of this invention will fuse together or “consolidate” under the pressure and stress conditions observed in a well fracture zone. This consolidation is an important property of coated proppants, as it indicates the ability of the proppant to remain “packed” in place and functioning in the well fracture zone. In addition, the cured epoxy coated particle would have reduced safety and environmental concerns when compared to phenolic coatings and their by-products.

The amine functional microgels have average particle sizes less than about 10 microns and preferably, have an average particle size range of about 0.05 to 1 microns.

Examples of polyfunctional epoxide compounds useful in the preparation of amine functional microgels of the present invention include epoxide compounds containing more than one 1,2 epoxide group in the molecule and which can be reacted with amine salts and polyamines to form the water dispersible curing agents in accordance with the invention. The term “polyfunctional epoxide compound” includes within its meaning the epoxy resins disclosed previously.

Illustrative of epoxy ethers useful in the practice of the present invention include those prepared by the reaction of epichlorohydrin in a basic medium with a polyhydric phenol. Illustrative of polyhydric phenols reactive with epichlorohydrin to prepare the epoxy ethers include polyhydric phenols such as resorcinol, hydroquinone, bis-(4-hydroxyphenyl)-methane, bis-(4-hydroxy-3-methylphenyl)-methane, bis-(4-hydroxy-3,5-difluorophenyl)-methane, 1,1-bis-(4-hydroxyphenyl)-propane, 2,2-bis(4-cyclohexanol)propane 2,2-bis-(4-hydroxy-3-methyl phenyl)-propane, 2,2-bis-(4-hydroxy-3-chlorophenyl)-propane, bis-(4-hydroxy phenyl)-phenyl methane, bis-(4-hydroxy phenyl) diphenyl methane, bis-(4 hydroxy phenyl)-4′-methyl phenyl methane, bis-(4-hydroxy phenyl) cyclohexyl methane, 4,4′ dihydroxydiphenyl, 2,2′ dihydroxy diphenyl, and polycyclopentadiene polyphenols.

In some embodiments, the above-mentioned polyfunctional epoxide compounds can be reacted individually or in admixture with a amine salt to prepare an epoxy intermediate which can then be reacted with a polyamine to prepare the microgels of the present invention.

In preparing the polyfunctional epoxide reactant for use in the preparation of the aqueous dispersions of an amine functional microgel of the present invention, in some embodiments, it may be advantageous to utilize an admixture of diglycidyl ether of a polyhydric phenol such as bisphenol A and an epoxy novolac and to incorporate in such admixture a quantity of a polydric phenol as a co-reactant.

In preparing the polyfunctional epoxide for reaction with the amine salt, it may be advantageous to dissolve the polyfunctional epoxide composition in a suitable solvent such as a glycol ether solvent (e.g., ethylene glycol monopropyl ether or ethylene glycol monobutyl ether).

Additional polyfunctional epoxy compounds useful in the practice of the present invention include phenol-aldehyde condensation products such as the glycidyl ethers of phenol-aldehyde resins such as the epoxy novolac resins. In some embodiments, the starting novolac material is the reaction product of a mono or dialdehyde, typically formaldehyde or paraformaldehyde with a phenolic material such as unsubstituted phenol and the various substituted phenols such as the cresols, alkyl and aryl substituted phenols such as p-tert-butylphenol, phenyl phenol and the like.

In a typical reaction scheme, the aldehyde, for example, formaldehyde, is reacted with the phenol under acidic conditions to prepare a polyphenolic material or novolac. In preparing epoxy novolac resins, the novolac is reacted with epichlorohydrin and dehydrohalogenated under basic conditions to produce the epoxy novolac resin. Epoxy novolac resins useful in the practice of the present invention generally have an average epoxy functionality of about 2 to 7.5 and, in some embodiments, about 2 to 4.

In some embodiments, the amine salts used to prepare the water reducible curing agents of the present invention are salts of tertiary amines and low molecular weight monocarboxylic acids having 1 to 3 carbon atoms such as formic acids, acetic acids, or lactic acid, with acetic acid being particularly preferred.

Any suitable tertiary amine may be used in the preparation of the amine salts of the present invention. However, in some embodiments, the tertiary amines include the aliphatic tertiary amines and their aromatic substituted derivatives such as triethylamine, tri-n-propylamine, triisopropylamine, tributylamine, dimethylaniline, higher homologous and isomeric trialkyl, dialkylaryl and alkyldiarylamines, various N-substituted tertiary amines having different organic radicals, for example, alkyl, aryl, alkaryl or aralkyl, on the amine nitrogen atom, benzyldimethylamine and methylbenzyldimethylamine, with cyclic compounds such as N-methyl morpholine and 4-ethyl morpholine, being preferred.

In some embodiments, the amine salt which is reacted with the polyfunctional epoxide compound in the practice of the present invention is prepared by simply mixing the tertiary amine and carboxylic acid at substantially equal molar ratios with or without external heat and in the presence or absence of volatile solvents as the reaction media.

To prepare the amine functional microgels of the present invention, a chemical excess of the polyfunctional epoxide compound is reacted with the amine salt. In some embodiments, the ratio of amine salt equivalents to epoxy equivalents ranges from about 0.05:1.0 to about 0.8:1, with the particular ratios of equivalents being in the range of about 0.1:1 to about 0.3:1.

Any suitable reaction conditions may be used. However, the reaction between the polyepoxide compound and amine salt is generally performed at a temperature of about 50° to 100° C., and preferably about 60° to 80° C. The reaction is generally completed in about 30 to about 90 minutes.

Polyamines suitable for reaction with the epoxy resin/amine salt reaction product include aliphatic, cycloaliphatic, araliphatic amines or mixtures thereof. Illustrative of the polyamines that can be used in the practice of the present invention are aliphatic, saturated or unsaturated bifunctional amines, such as lower aliphatic alkylene polyamines, for example, ethylene diamine, 1,2-propylene diamine, 1,3-propylene diamine, 1,4-butylene diamine, hexamethylene diamine, 2,2,4-(2,4,4) trimethyl hexamethylene diamine, polyalkylene polyamines, for example, homologous polyethylene polyamines such as diethylene triamine, triethylene tetraamine, tetraethylene pentamine or analogous polypropylene polyamines such as for example analogous polypropylene polyamines such as dipropylene triamine. Preferred amines include isophorone diamine, m-xylene diamine, diaminocyclohexane, trimethylhexamethylene diamine, polyoxypropylene di and tri-amines, (poly)ethylene amines, methylene dicyclohexyl amine, and aminoethylpiperazine.

Additional additives that may be included in the compositions include, but are not limited to, pigments, polyurethane dispersions, thermoplastic resins (e.g., ethylene-vinyl acetate copolymers), alkyds, processing agents, fillers, pigments, dispersing agents, foam reducing agents, wetting agents, anti-caking agents, adhesion promoters, rubber tougheners, and anti-static agents.

The present invention will now be described in more detail with reference to the following examples. However, these examples are given for the purpose of illustration and are not to be construed as limiting the scope of the invention.

### EXAMPLES

### Example 1

3000 grams of 40/70 mesh brown sand and 3 grams of glycidoxy propyl trimethoxy silane available as Z 6040 from Dow Corning were premixed in a mixing vessel with a paddle blade for one minute. 375 grams of an aqueous dispersion of an amine functional microgel available as Epotuf® 37-680 from Reichhold, Inc, was added and mixing was continued for about 5 minutes. The wet resin coated sand was then poured onto aluminum foil sheets in a thin layer to dry. The sand was moved periodically using a spatula during the initial drying to prevent clumping and aid the drying process. The sand was then air dried overnight at room temperature and then baked at 204° C. for 1 hour in aluminum pans the following day. The sand was then passed through sieves and the material with mesh size between 40 and 70 was collected to further testing.

### Examples 2-4

500 grams of 40/70 mesh brown sand and 0.5 grams of glycidoxy propyl trimethoxy silane were mixed together. A mixture of 62.5 grams of Eputuf® 37-680 amine functional microgel and 17.1 grams of additive as detailed below was formed and added to the 40/70 sand and Z6040 mixture, The mixing was continued for 5 minutes. The wet resin coated was then poured onto aluminum foil sheets in a thin layer to dry. The sand was moved periodically using a spatula during the initial drying to prevent clumping and aid the drying process. The sand was then dried overnight at room temperature and then baked at 204° C. for 1 hour in aluminum pans the following day. The sand was then passed through sieves and the material with mesh size between 40 and 70 was collected to further testing. An additive was included as follows:

| Example | Additive |
|---|---|
| 2 | Urotof L-55 polyurethane dispersion |
| 3 | Beckosol AQ-105 alkyd dispersion |
| 4 | Synthemul ethylene vinyl acetate copolymer |

The coated and uncoated 40/70 sands were tested for crush resistance at 5000 psi in accordance with American Petroleum Institute test method RP 56.

| Example | % Fines After Crush Test (5000 psi) |
|---|---|
| Uncoated 40/70 sand | 10.5 |
| 1 | 1.5 |
| 2 | 1.0 |
| 3 | 1.1 |
| 4 | 1.2 |

Examples 1-4 demonstrate that the resin coated particulate of the invention has improved crushability properties with or without various additives.

### Example 5

500 grams of 40/70 brown sand and 0.5 grams of glycidoxy propyl trimethoxy silane were mixed together, 62.5 grams of Epotuf® 37-680 amine functional microgel was added to the 40/70 sand and Z6040 mixture. The mixing was continued for 5 minutes. The wet resin coated was then poured onto aluminum foil sheets in a thin layer to dry. The sand was moved periodically using a spatula during the initial drying to prevent clumping and aid the drying process. The sand was baked at 204° C. for 20 minutes in an aluminum pan. The sand was then passed through sieves and the material with mesh size between 40 and 70 was collected to further testing. The particulate had 6.4% fines when tested at 10,000 psi and had an unconfined compressive strength of 572 psi after 4 hours of storage at 250° F. under a pressure of 1000 psi with a 2% aqueous potassium chloride solution.

This unconfined compressive strength test demonstrates that the coated sand of this invention will fuse or consolidate under the conditions of heat and stress in a well fracture zone. For comparison purposes, a premium quality commercial sand with a phenolic coating will achieve approximately 350 psi compressive strength under these same conditions,

### Example 6

A sample was prepared according to the procedure in Example 5 and was mixed with 0.23 grams of cocaminopropyl betaine (Chembetaine CGF) antistatic agent after baking. The particulate had 6.2% fines when tested at 10,000 psi and had an unconfined compressive strength of 460 psi.

### Example 7

500 grams of 40/70 brown sand and 0.5 grams of glycidoxy propyl trimethoxy silane were mixed together. 6.5 grams of a standard grade of diglycidyl ether of Bisphenol A resin (Epotuf 37-140) was added and mixed for 5 minutes followed by addition of 47.1 grams of Epotuf® 37-680. The mixing was continued for 5 minutes. The wet resin coated was then poured onto aluminum foil sheets in a thin layer to dry. The sand was moved periodically using a spatula during the initial drying to prevent clumping and aid the drying process. A portion of the sand was dried overnight at room temperature and then baked at 204° C. for 20 minutes in an aluminum pan the following day and then mixed with 0.23 grams of Chembetaine CGF. The particulate had 3.5% fines when tested at 10,000 psi.

### Example 8

A sample was prepared as in Example 7 except the coated sand was dried at 120° C. for 20 minutes. This material had 1.6% fines when tested at 10,000 psi, while the uncoated sand had 32.3% fines.

### Examples 9-12

Samples were prepared as in Example 8 except different grades of a high quality Ottawa sand (also known as white sand) were used. The following table lists the % fines generated when crushed at 10,000 psi for the uncoated sand and the resin coated particulate.

| Sand sample | Size | Uncoated | Coated |
|---|---|---|---|
| 9 | 40/70 | 18.0 | 0.5 |
| 10 | 40/70 | 16.6 | 0.2 |
| 11 | 20/40 | 39.5 | 1.1 |
| 12 | 20/40 | 37.5 | 0.5 |

### Example 13

600 grams of 40/70 brown sand and 0.6 grams of glycidoxy propyl trimethoxy silane were mixed together. 7.8 grams of Epotuf 37-140 was added and mixed for 5 minutes followed by addition of 56.5 grams of Epotuf® 37-685 intermediate. The mixing was continued for 5 minutes. The wet resin coated was then poured onto aluminum foil sheets in a thin layer to dry. The sand was moved during the drying to prevent clumping and aid the drying process. A portion of the sand was dried overnight at room temperature and then baked at 120° C. for 20 minutes in an aluminum pan the following day and then mixed with 0.27 grams of Chembetaine CGF. The particulate had 4.7% fines when tested at 10,000 psi.

### Example 14

A sample was prepared as in Example 13 except 7.9 grams of a diglycidyl ether of Bisphenol A blended with an epoxidized C12-14 alcohol (Epotuf 37-127) was used in place of Epotuf 37-140, and 52.6 grams of Epotuf 37-680 was used in place of Epotuf 37-685. This particulate had 4.5% fines when tested at 10,000 psi.

### Example 15

A sample was prepared as in Example 13 except a combination of 7.8 grams of Epotuf 37-127 and 0.78 grams of EPOTUF® G-293, an acrylonitrile-butadiene rubber modified liquid epoxy resin with an average epoxide equivalent weight of 340 and a rubber content of 40%, was used in place of Epotuf 37-140 and 56.5 grams of Epotuf 37-680 was used in place of Epotuf 37-685. This particulate had 2.1% fines when tested at 10,000 psi.

### Example 16

A sample was prepared as in example 13 except 10.3 grams of a diglycidyl ether of Bisphenol A supplied as a 78% solids dispersion in water (Epotuf 37-143) was used in place of Epotuf 37-140 and 52.4 grams of Epotuf 37-680 was used in place of Epotuf 37-685. This particulate had 3.6% fines when tested at 10,000 psi. Examples 5-16 demonstrate that a particulate coated with a resin derived from various epoxy-functional compounds and amine functional microgels have improved crushability.

Many modifications and other embodiments of the inventions set forth herein will come to mind to one skilled in the art to which these inventions pertain having the benefit of the teachings presented in the foregoing descriptions and the associated figures. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A resin coated particulate for use in oil and gas subterranean extractions comprising
a particulate substrate; and
a resin coating comprising epoxy-functional compounds and an aqueous dispersion of an amine functional microgel wherein the amine functional microgel is formed by reacting a chemical excess of a polyfunctional epoxide compound with an amine salt to form a polyfunctional epoxide amine salt reaction intermediate product, and condensing at least some of the unreacted epoxide groups of the polyfunctional epoxide amine salt reaction intermediate product with a polyamine.

2. The resin coated particulate of claim 1 wherein the polyfunctional epoxide amine salt reaction intermediate product containing the unreacted epoxy groups is condensed with the polyamine in the ratio of about 0.3:1.0 to about 1.3:1.0 moles of amine to epoxy equivalents.

3. The resin coated particulate of claim 1 wherein the polyfunctional epoxy compound comprises an epoxy novolac.

4. The resin coated particulate of claim 3 wherein the epoxy novolac is the glycidyl ether of a phenol-formaldehyde condensate.

5. The resin coated particulate of claim 1 wherein the polyfunctional epoxy compound is a mixture of the glycidyl polyether of a polyhydric phenol and an epoxy novolac resin.

6. The resin coated particulate of claim 1 wherein the polyfunctional epoxide compound is a mixture of a glycidyl ether of a dihydric phenol and an epoxy novolac resin reacted in the presence of a polyhydric phenol.

7. The resin coated particulate of claim 6 wherein the polyhydric phenol is bisphenol A.

8. The resin coated particulate of claim 1 wherein the polyamine containing one or more primary amine groups per molecule selected from the group consisting of isophorone diamine, m-xylene diamine, diaminocyclohexane, trimethylhexamethylene diamine, polyoxypropylene di and tri-amines, (poly)ethylene amines, methylene dicyclohexyl amine, and aminoethylpiperazine.

9. The resin coated particulate of claim 1 wherein the particulate substrate has a diameter of 40 to 4000 microns.

10. The resin coated particulate of claim 1 wherein the epoxy functional compound is an epoxy silane.

11. The resin coated particulate of claim 10 wherein the epoxy silane is glycidoxy propyl trimethoxy silane.

12. The resin coated particulate of claim 10 wherein the particulate substrate is sand.

13. The resin coated particulate of claim 10 wherein the resin coating further comprises an epoxy.

14. The resin coated particulate of claim 13 wherein the epoxy is a glycidyl ether of a polyhydric phenol and/or a (poly)hydric alcohol having an epoxide equivalent weight of from about 120 to about 700.

15. The resin coated particulate of claim 13 wherein the epoxy is a diglycidyl ether of bisphenol A.

16. A method of treating a subterranean fracture comprising injecting into a well resin coated particulate comprising a particulate substrate and a resin coating comprising epoxy-functional compounds and an aqueous dispersion of an amine functional microgel wherein the amine functional microgel is formed by reacting a chemical excess of a polyfunctional epoxide compound with an amine salt to form a polyfunctional epoxide amine salt reaction intermediate product, and condensing at least some of the unreacted epoxide groups of the polyfunctional epoxide amine salt reaction intermediate product with a polyamine.

17. The method of claim 16, wherein the particulate substrate has a diameter of 40 to 4000 microns.

18. The method of claim 16, wherein the particulate substrate is sand.
